(19) United States
(12) Patent Application Publication
(10) Pub. No.: US 2014/0278057 A1
(43) Pub. Date: Sep. 18, 2014

(54) SYSTEM AND METHOD FOR AUTOMATICALLY CALENDARING EVENTS AND ASSOCIATED REMINDERS

(71) Applicant: John Michael Berns, Eagan, MN (US)

(72) Inventor: John Michael Berns, Eagan, MN (US)

(21) Appl. No.: 13/844,068

(22) Filed: Mar. 15, 2013

(51) Int. Cl. G01C 21/34

(52) U.S. Cl. CPC G01C 21/34
USPC 701/410; 701/533; 701/465

(57) ABSTRACT

A method and structure for automatically scheduling a meeting and associated reminders in an electronic calendar system combining location, time, traffic, and weather conditions. Calendars and locations of one or more participants invited to a meeting being scheduled are accessed. A participant's location and a corresponding weather, traffic, or other data is checked to determine an anticipated travel time to the meeting, and the participant is advised when the participant must depart for the meeting.

### BACKGROUND OF THE INVENTION

1. Field of the Invention

The invention relates to electronic calendars. More specifically the invention relates to scheduling events and reminders on an electronic calendar by factoring locations, weather, traffic, and other factors that govern the time needed to reach a meeting location.

2. Background Art

Calendaring is a technique of recording upcoming events for the purpose of reminding a user (whether an individual or a group) of upcoming events. A user may use a paper calendar or diary, a large desk mat, or a computerized system. Today calendaring is a standard feature of many software packages, personal computers (PC), tablet computers (Tablet), personal digital assistants (PDAs) and phones. These systems have made it relatively simple to enter an event into a calendar in a precise and easy to understand manner. The electronic calendar can assist the user in identifying conflicts or scheduling overlaps, but typically suffer from the defect that they only consider the time of the meeting itself, unless the user separately or manually enters travel time between meetings.

However, today's consumers, professionals, and individuals are highly mobile, often traveling between several locations in the course of a day. A sales representative may have meetings in several locations, and must calculate how long he needs between meetings manually. A large corporation may have several campuses in a metro area. An individual working for that corporation may have meetings or work spread out over several locations. An individual officed in downtown Minneapolis may wish to take a first meeting downtown, followed by a subsequent meeting in Bloomington. If that second meeting is scheduled too closely to the first he may be unable to make that meeting. Yet, conventional electronic calendars allow that second meeting to be scheduled too closely on the heels of the first, as they do not account for the travel time. This leaves the user to manually revise meetings or indicate his availability.

This necessitates more time on the user's part, and can lead to friction when having to cancel, reschedule, or drop out of a meeting that another party scheduled in a time slot for which the user initially appeared available.

### BRIEF SUMMARY OF THE INVENTION

The present invention solves this difficulty by accounting for the location of the user and the travel time needed to reach the location set for a second event. The invention includes a platform which includes an input mechanism configured to receive input, a calendar, and a scheduling program that receives a user location and an event location, calculates a travel time between the user location and the event location, and determine if the user can attend the event.

The platform can be a mobile device, a personal computer, or a network. The platform can include a processor, a memory, a system interconnect/bus, input devices, output devices, storage and memory, and network interface(s).

The scheduling program can receive the user location by previewing the calendar to determine a prior location associated with a prior event, by receiving a user location from user settings, the user settings defining preset locations for the user, or by user input. The scheduling program can be configured to receive the user location by determining a real time location of the user, e.g., from one or more devices, such as a mobile device. In one embodiment the scheduling program consults multiple devices to determine the real time location of the user and assigns weights to each data point based on its reliability in determining the user's location. The scheduling program may calculate the user's location multiple times. For example, the calculation may be performed when the event is first calendared, when the event or nearby events are changed, and when the event is imminent.

In another embodiment, the scheduling program calculates the travel time by determining a route between the user location and the event location. The scheduling program may configure the travel time by determining a current traffic condition on the determined route, by determining a current weather condition on the determined route, or both, or by considering other factors that will impact travel time.

In another embodiment, the scheduling program is configured to set a reminder for the user to depart a sufficient time before the event to attend on time. The reminder may be adjusted to give the user a buffer of time to arrive. The scheduling program can be configured to recalculate the travel time prior to the event, and further configured to adjust the reminder if the travel time has changed.

In another embodiment, the invention is a method implemented on an electronic calendar apparatus by a processor configured to execute instructions that, when executed by the processor, direct the electronic calendar apparatus to receive a user location, receive an event location, calculate a travel time between the user location and the event location, and determine if the user can attend the event. The invention may further include the step of consulting a mobile device to learn a real time location of the user. The method may further include the step of determining a route between the user location and the event location.

The method may further include steps of consulting a traffic service or weather service to determine a traffic condition or weather condition at or near the time the user will travel between the user location and the event location.

In another embodiment the invention is a computer program product that includes computer executable code. When the code is executed on one or more computer devices it performs the steps of determining a user location, determining an event location, calculating a travel time between the user location and the event location, determining if the user can attend the event, adding the event to the calendar, calculating a reminder time based on the event time and the travel time; and adding a reminder to the calendar.

### BRIEF DESCRIPTION OF THE DRAWINGS

FIG. 1 is block diagram illustrating a basic platform and its components.

FIG. 2 is a flow diagram illustrating the major steps of one preferred embodiment of the present invention.

FIG. 3 is a flow diagram illustrating the determine user location substeps of one embodiment of the present invention.

FIG. 4 is a flow diagram illustrating the determine actual user location substeps of one embodiment of the present invention.

FIG. 5 is a flow diagram illustrating the calculate travel time substeps of one embodiment of the present invention.

### DETAILED DESCRIPTION OF THE INVENTION

The embodiments described herein include a method, system, and computer program for managing an individual or group's meeting calendar and associated reminders. In particular, a scheduling utility determines the location of a user, the location of an event, and determines the amount of time necessary to reach the meeting. In this description of embodiments of the invention, specific embodiments in which the invention may be practiced are described to enable those skilled in the art to practice the invention. Other embodiments may be used and logical, architectural, programmatic, mechanical, electrical and other changes may be made without departing from the spirit or scope of the present invention. The following description is not limiting, and the scope of the invention is defined only by the claims.

Modern electronic calendar systems can rely on one or more platforms for input and output of a calendar and events: a PC, a tablet, a PDA, a phone, or another electronic device. Many of these devices, such as a phone, a laptop PC, a PDA, or a tablet are mobile and travel with the user. As an exemplary calendaring system, many corporate calendar systems rely on Microsoft™ Outlook™ personal information manager. Using this or another calendar program, a user can enter events into his personal calendar from his desktop or laptop computer. The user can also invite others to such events, reserve conference rooms or other spaces and utilities, and the like. Likewise, with Google™ Calendar the user may enter events from a computer onto a calendar. Some such systems can allow data input and output from more than one computer, or even more than one platform. For example, the user may have multiple computers and may enter events from each. The user may also set up delegates, other users who can enter events onto the primary user's calendar. These delegates may have varying levels of authority. Finally, a user may also wish to enter data from multiple systems onto the same calendar. For example, the user may carry a smartphone, have a laptop, a tablet, and a personal computer, and may use each to enter events onto the calendar and to view her schedule.

Preferably the system will sync data entered on each of the different systems, and on occasion must reconcile differences. For example, each event as it's entered may have a modification date or time. When a calendar on one device is synced with the calendar on another device, or with a server containing the user's calendar, the device may upload and download only new events that have a modification date stamp after the last download. If there is a conflict, the system may resolve the conflict by accepting the last modified event, the first modified event, or the entry from a specific platform. Likewise, the system may ask the user which entry to accept.

At times, calendar data from two different platforms will be sent to the user's calendar, and the data must be translated from one calendar data representation into another. For example, on one platform the calendar data may be presented in iCalendar format and in a second platform the calendar data may be presented in hypertext markup language (HTML). These formats are exemplary and other formats may be used, in any combination and in any number. iCalendar, developed by the Internet Engineering Task Force (IETF), is a pseudo-standard for a payload data format for transporting calendar items over e-mail. IETF is the protocol engineering and development arm of the Internet (IETF Secretariat c/o Corporation for National Research Initiatives 1895 Preston White Drive, Suite 100 Reston, Va. 20191-5434). While calendar data in an iCalendar format representation is relatively high-fidelity, it may only be accessible to users that use iCalendar-enabled reader applications. Consequently, a platform that only uses HTML data will need data translated before it's sent to that platform, Synchronization may occur via peer-to-peer sharing, network connection, Wi-Fi connection, or wireless connection, for exemplary purposes.

The events so entered may be stored on one or more hard drives, internal networks, external networks, or other memory sources. Multiple calendars can be created and shown in the same view. A user may allow others to see all or portions of his calendar. If so, in embodiments of the invention the user may include the ability to schedule to his calendar. For example, the calendars may be marked with an extension property that identifies them as schedulable. The user may indicate what portion of his calendar is schedulable, and by whom.

With reference now to FIG. 1, depicted is a block diagram representation of platform 100. Platform 100 typically comprises any suitable combination of hardware, software, and/or firmware that can be used to implement a calendar system. In particular, where a single unit is mentioned, multiple units may be present, such as multiple CPUs, either as a multi-core processor or as multiple components Likewise, one unit may combine or perform several elements described below.

Platform 100 may comprise a processor or central processing unit (CPU) 110 connected to a memory 120 via system interconnect/bus 130. Also connected to system bus 130 is I/O controller 140, which provides connectivity and control for input devices, of which pointing device (or mouse) 150 and keyboard 155 are illustrated, and output devices, of which display 160 is illustrated. Other storage, input, and output elements may be present, e.g., a multimedia drive (not shown) (e.g., CDRW or DVDRW drive) and Universal Serial Bus (USB) hub (not shown) and would be coupled to I/O controller 120. Platform 100 also comprises storage 180, within which data/instructions/code may be stored. Platform 100 is also illustrated as having network interface device (NID) 190 coupled to system bus 130. NID 190 enables platform 100 to connect to another platform or to one or more remote servers via access networks, an internal network, the Internet, or wireless networks, such as a cellular network. NID 190 may serve as either an input or an output means for calendaring events and data.

In the described embodiments, when the access network is the Internet, the access network represents a worldwide collection of networks and gateways that utilize the Transmission Control Protocol/Internet Protocol (TCP/IP) suite of protocols to communicate with one another. Of course, network access may also be provided via a number of different types of networks, such as an intranet, an Ethernet, a Local Area Network (LAN), a Virtual Private Network (VPN), or other Wide Area Network (WAN) other than the Internet, for example.

Notably, in addition to the above described hardware components of platform 100, various features of the invention are completed via software (or firmware) code or logic stored within system memory 120, in other storage (e.g., storage 180), or stored remotely, e.g., on the internet or in memory of a remote server (not shown), and executed by CPU 110. In one embodiment, data/instructions/code stored in the remote memory of a remote server populates the system memory 120, which is also coupled to system bus 110. In another embodiment, the data/instructions/code are stored and executed remotely from a remote server and accessed by Platform 100 via NID 190.

Illustrated within system memory 120 are a number of software/firmware components, including operating system (OS) 200 (e.g., Microsoft Windows™ or GNU®/Linux™, or Advanced Interactive eXecutive-AIX-™, applications 205, Basic Input/Output System (BIOS) 210 and scheduling utility 300. For simplicity, scheduling utility 300 is illustrated and described as a standalone or separate software/firmware component, which is stored in system memory 120 to provide/support the specific novel functions described herein. However, scheduling utility 300 may reside in system memory 120, storage 180, a remote memory, a remote server, or on the internet. Scheduling utility 300 may also be incorporated into operating system 200 or another portion of the software on the platform.

CPU 110 may execute scheduling utility 300 as well as operating system 200, or may be dedicated to scheduling utility 300 and supports the user interface features of scheduling utility 300. In the illustrative embodiment, scheduling utility 300 facilitates the automatic management of an event calendar. Among the software code/instructions provided by scheduling utility 300, and which are specific to the invention, are code for: (a) selecting a user location for a user; (b) selecting an event location for an event; (c) determining a travel time from the user location to the event location, and (d) generating and outputting at least one indication of that travel time.

Each of these steps may be performed one or more times, in one or more contexts. For example, with reference to FIG. 2, in one embodiment the scheduling utility 300 will identify a user location 400 prior to the event, and identify the event location 500. The scheduling utility 300 will then utilize this data to calculate the travel time 600, determine 700 if the user can attend the event, either add the event to the calendar 800 and set a reminder 810 for the user to depart (at the event time—the travel time (plus any user desired buffer)), and block off the travel time 820. The reminder 810 preferably includes the location of the event, and if relevant, a navigational link for travel to the event (e.g., a link to open Google™ Navigation to the address on an Android smartphone). The scheduling assistant 300 may also reject 900 the event if there is insufficient travel time, or alternatively may alert the user for handling. Finally, if the scheduling assistant 300 determines that the user is not able to physically attend the event, it may seek to determine if there are other mechanisms for attending, such as nearby videoconferencing equipment (in a conference room, on a user laptop or cell phone) or if there is a telephone call in number. If so, the scheduling assistant 300 may notify the user (via an alert on a currently active device, email, text message, or phone call) of the change and may prompt him to accept or reject the revised event. If accepted, the scheduling assistant 300 may set a revised reminder pop up to include the new connection information for the event.

With reference to FIG. 3, there are many ways the scheduling utility 300 can determine the user location 400. For instance, at the time the event is scheduled (well in advance of the event) the scheduling assistant 300 can preview the user's calendar to determine where prior events 420 are being held, and determine that the user is likely to be in that location prior to the event. The scheduling assistant 300 can also consult user settings 430, e.g., where the user typically is at that time of day or day of week. A user may set the system to recognize that she is typically in her office Monday-Friday from 9 a.m. to 6 p.m., at the gym on Wednesday morning, and the like. Finally, scheduling assistant 300 may ask one or more actors for input 440. The scheduling assistant 300 may prompt the user to enter a location she will depart from for the event 445, a user's delegate 450, or the event organizer 455.

While the scheduling assistant 300 may follow the steps in FIG. 3 at any time, and at multiple times (for instance, as other events get added to or removed from the calendar), the scheduling assistant 300 may advantageously update the travel time 600 as the event draws near. With reference to FIG. 4, as the event draws near, e.g., the day of the event or at a time before the user must depart for the event, the scheduling assistant 300 may more frequently check the user location 400 to determine the travel time 600. In particular the system may determine that as the event is imminent, it will attempt additional means to determine the user's location by determining the real time location 410 of the user. The scheduling assistant 300 may consult many factors to determine the real time location 410. For instance, the scheduling assistant 300 may consult a PDA or cellular phone for the GPS, Wi-Fi, or cellular tower location of the user 411. The scheduling assistant 300 may consult a user's laptop for a laptop location 412 (e.g., determined by Wi-Fi location data, network access, or user input). The scheduling assistant 300 may also consult the calendar for a prior event location 413, the user's office location 414, past travel patterns and history 415, and user settings or input 416. Further, the scheduling assistant 300 may consult the user's PC to determine if it is in use 417. Many automobiles today are internet enabled, and include GPS systems. As a result, the scheduling assistant 300 may consult a vehicle for its location 418. The scheduling assistant 300 may determine if the vehicle or another device is in motion or not. Numerous other devices 419 are internet connected and determine locations, and the scheduling assistant 300 may consult any of these devices.

While the scheduling assistant 300 may consult any or all of these, and weight the factors according to the design and judgment of the system administrators or the user, it is considered particularly advantageous for the system to consult the current location of multiple devices. For instance, if the user's cell phone and laptop register with similar locations, it is highly likely that the user is present as well. If the user's PC is in active use, e.g., typing or web browsing, and his phone registers in a similar location to that set or discovered for his PC, it is highly likely the user is present. If the user's vehicle is in motion and its location tracks the motion of the user's cell phone, it is highly likely the user is present. The exact weight the scheduling assistant 300 assigns to each factor is subject to the preferences of a system designer and will not be detailed here.

In particular, however, it is not necessary that the system consult the device that the event was calendared on, or that the calculations be performed on the device that the user is currently using. If one particular device is performing the calculations, it may seek information from another device.

The scheduling assistant 300 must also determine the event location 500. As above, there are multiple ways to determine an event location 500. For example, the platform 100, scheduling assistant 300, or a related system, may store data as to event locations. At the time the event is scheduled the event organizer may choose an event location from a set of options, e.g., a drop down box. Likewise, the event organizer is able to enter a street address or the like. The user may also set or modify event location 500. The scheduling assistant 300 may predict an event location 500 from a meeting title, attendees, or subject matter. For example, the scheduling assistant 300 may identify a location from the address for a contact stored in a user's contacts file. Likewise, the scheduling assistant 300 may be preset to auto-populate a meeting with a particular contact at a particular location. Finally, the scheduling assistant 300 may learn. If a user always meets with a particular contact at a diner, the scheduling assistant 300 will prepopulate the event location 500 as that diner.

The system may also search for an available conference room on a conference room scheduling system (not shown), and choose a conference room. The conference room may be chosen based on a number of criteria, including those conference rooms available at the meeting time, the number of attendees, and the location in the building within which the attendees are located. It may also be chosen based on anticipated or actual locations of the attendees.

With reference to FIGS. 2 and 5, the scheduling assistant 300 will take the user location 400 and the event location 500 as data for calculating the travel time 600. While in one embodiment the scheduling assistant 300 considers a set user location 400 and event location 500 and calculates a travel time 600 from this data, the scheduling assistant 300 may also start from a time available between events and determine a location for one or both events such that the user (and or other attendees) can attend both events.

To determine the travel time 600, the scheduling assistant 300 may consider the mode of travel 610. For instance, the user or administrator may preset a particular mode of travel 610 for all events. This preset may be changeable or unchangeable. The preset may be variable, for instance travel between two events on a particular school campus may be calculated assuming the user is walking. Travel between two nearby cities may be estimated as driving, or using public transportation Likewise, the scheduling assistant 300 may consider weather conditions in deciding what mode of travel is appropriate. The scheduling assistant 300 may also prompt a user or event organizer to enter a travel mode.

If the travel mode is selected or set, the scheduling assistant 300 may then simply measure the distance between locations and estimate the travel time 600. The scheduling assistant 300 may also calculate a route 620 using means known in the art, e.g., navigation guided by maps 621 available from commercial sources and commonly used in GPS receivers. The scheduling assistant 300 may also use online map data 622. The scheduling assistant 300 may also consult traffic patterns 623, current traffic conditions 624, weather 625, and user preferences 626 to determine the route.

Once a route 620 is determined, the scheduling assistant 300 may determine the travel time 600. In calculating the travel time, the scheduling assistant 300 may simply estimate the travel time 600 from map data 621 or 622 and the two locations.

However, the scheduling assistant 300 may also account for known traffic patterns 623 at the time of day the travel occurs. For instance, if the user must leave an office on the north side of town during rush hour, and travel to the south side of town for the event, it is very likely he will encounter slower traffic conditions for all or a portion of the trip. Accordingly, scheduling assistant 300 may account for this increased traffic and slower travel speeds. If the event is imminent, the scheduling assistant 300 may consider the current traffic conditions 624. The scheduling assistant 300 may consider the weather 625 as inclement weather may delay travel. The scheduling assistant 300 may also consider the travel patterns (e.g., speed, etc.) of the user 627. In addition a user's travel preferences 626 may be consulted. Some users may prefer to take public transportation. Some prefer to stay off highways when driving, others prefer the interstate. Some will drive slower than others. The scheduling assistant 300 may consider each of these factors, or disregard each.

As with calculating the user location 400, the travel time 600 may be calculated on multiple occasions: when the event is first established, when the event is updated or changed, when other events are updated or changed, and when the event is imminent. Particularly when the event is imminent, the scheduling assistant 300 may consider—in addition to or otherwise—traffic patterns and density, current or anticipated weather, as well as any “live” factors that may impact the travel time 600. Should a recalculation of the travel time 600 result in an earlier required departure or an overlap with a prior event, the scheduling assistant 300 may alert the user via the methods discussed earlier.

Once the scheduling assistant 300 has determined the travel time 600, the scheduling assistant 300 determines 700 if the user can attend the event, either (1) adds the event to the calendar 800 and sets a reminder 810 for the user to depart (at the event time—the travel time (plus any user desired buffer)), and blocks off the travel time 820, or (2) rejects 900 the event.

Example 1: The user has a 10 a.m. sales call on Oak Street. The sales call is expected to last 1 hour. He is invited to lunch at a café downtown at noon. The system determines that the travel time is 45 minutes, and he can make it. Thus the event is accepted (either automatically or by the user based on a system indication that the event is acceptable) and calendared 800. In this case the user must leave at 11:15 to arrive on time. However, he prefers a 15 minute buffer, so the scheduling assistant 300 schedules his reminder 810 at 11:00 a.m. The system blocks 820 the time from 11:00 a.m. to noon as travel time (as well as the lunch time, from noon to 1:00 p.m.).

Example 2: As with example 1, the user has a 10 a.m. sales call and receives an invitation for a noon lunch 45 minutes away. However, an accident on the main highway leaves traffic at a standstill, and the user cannot make both meetings. The system recognizes that he is unable to attend, and either rejects 900 the lunch, shows the time as blocked to the person inviting the user to lunch, or notifies the user as to the conflict.

Example 3: The user has previously accepted both the 10 a.m. sales call and the noon lunch based on a predicted travel time of 45 minutes. However, at 10:45 a.m. an accident on the main highway leaves traffic at a standstill and the user can no longer arrive on time. The system can notify the user via his preferred mechanism (e.g., call, text, email, etc.) of the conflict. If desired, the system can also automatically notify the user's lunch partner of the problem.

The reminder 810 preferably includes location of the event, and if relevant, a navigational link for travel to the event (e.g., a link to open Google™ Navigation to the address on an Android smartphone). The scheduling assistant 300 may alternatively alert the user for handling. Finally, if the scheduling assistant 300 determines that the user is not able to physically attend the event, it may seek to determine if there are other mechanisms for attending, such as nearby videoconferencing equipment (in a conference room, on a user laptop or cell phone) or if there is a telephone call in number. If so, the scheduling assistant 300 may notify the user (via an alert on a currently active device, email, text message, or phone call) of the change and may prompt him to accept or reject the revised event. If accepted, the scheduling assistant 300 will set a reminder pop up that may be revised to include the new connection information for the event.

In one embodiment, the scheduling assistant 300 can monitor a phone conversation or an email exchange for indications that the participants want to meet. Upon such an indication, the scheduling assistant 300 can provide an option to the user to schedule the meeting, and depending on locations, can propose a meeting location. Alternatively, the scheduling assistant 300 may simply advise the user that such a meeting is possible (e.g., via a green light on the phone screen or email) or is impossible (via a red light). Visual, audio, haptic, and other feedback can be used to advise the user such that it will not interfere with the conversation format. Trigger words could include “meet” or “meeting”, discussions of times, and similar factors.

In one embodiment, the system may track when a user arrives at a meeting, and adjust the future departure reminders based on the actual travel time for the user. The system may rely on an input from the user for the departure and arrival times to track this length of travel, or may rely on an automated system, such as a GPS location service, or a cell tower location triangulation for departure and arrival times. The user may set it to confirm the adjusted time, or to simply allow automated changes.

1. A platform, comprising:
an input mechanism configured to receive input;
a calendar;
a scheduling program configured to:
receive a user location;
receive an event location;
calculate a route from digital map data between the user location and the event location;
calculate a travel time between the user location and the event location; and
determine if the user can attend the event

2. The platform of claim 1, wherein the platform is a mobile device.

3. The platform of claim 1, wherein the scheduling program further comprises a network interface device.

4. The platform of claim 1, wherein the scheduling program is further configured to receive the user location by previewing the calendar to determine a prior location associated with a prior event.

5. The platform of claim 1, wherein the scheduling program is further configured to receive the user location by receiving a user setting, the user setting defining preset locations for the user.

6. The platform of claim 1, wherein the scheduling program is further configured to receive the user location via a user input.

7. The platform of claim 1, wherein the scheduling program is further configured to receive the user location by determining a real time location of the user.

8. The platform of claim 7, wherein the scheduling program is further configured to consult a mobile device to determine the user's real time location.

9. The platform of claim 8, wherein the scheduling program is further configured to consult a second device to determine the user's real time location.

10. The platform of claim 1, wherein the scheduling program is further configured to calculate the travel time by determining a route between the user location and the event location.

11. The platform of claim 10, wherein the scheduling program is further configured to calculate the travel time by determining a current traffic condition on the determined route.

12. The platform of claim 10, wherein the scheduling program is further configured to calculate the travel time by determining a current weather condition on the determined route.

13. The platform of claim 1, wherein the scheduling program is configured to set a reminder for the user to depart a sufficient time before the event to attend on time.

14. The platform of claim 13, wherein the scheduling program is configured to recalculate the travel time prior to the event, and further configured to adjust the reminder if the travel time has changed.

15. A method implemented on an electronic calendar apparatus by a processor configured to execute instructions that, when executed by the processor, directs the electronic calendar apparatus to perform steps comprising:
receiving a user location;
receiving an event location;
calculating a route from digital map data between the user location and the event location;
calculating a travel time between the user location and the event location;
determining if the user can attend the event; and
automatically advising the user of the result.

16. The method of claim 15, further comprising the step of consulting a mobile device to learn a real time location of the user

17. The method of claim 15, further comprising the step of determining a route between the user location and the event location.

18. The method of claim 17, further comprising the step of consulting a traffic service to determine a traffic condition at or near the time the user will travel between the user location and the event location.

19. The method of claim 17, further comprising the step of consulting a weather service to determine a weather condition at or near the time the user will travel between the user location and the event location.

20. A method implemented on an electronic calendar apparatus by a processor configured to execute instructions that, when executed by the processor, directs the electronic calendar apparatus to perform steps comprising:
determining a user location;
determining an event location;
calculating a travel time between the user location and the event location;
determining if the user can attend the event;
adding the event to the calendar;
automatically calculating a reminder time based on the event time and the travel time; and
automatically adding a reminder to the calendar.
